(19) United States
(12) Patent Application Publication
(10) Pub. No.: US 2010/0212300 A1
(43) Pub. Date: Aug. 26, 2010

(54) Exhaust Purification With On-Board Ammonia Production

(75) Inventors: Scott B. Fiveland, Metamora, IL (US); James J. Driscoll, Dunlap, IL (US); Kevin L. Bruch, Peoria, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/710,455

(22) Filed: Feb. 23, 2010

Related U.S. Application Data
(60) Provisional application No. 61/155,306, filed on Feb. 25, 2009.

(51) Int. Cl. F01N 9/00; F01N 3/10; F02B 75/02; F02B 69/06

(52) U.S. Cl. 60/287; 60/299; 123/64; 123/21

(57) ABSTRACT

A method of operating an engine system comprising operating a first cylinder group at a first number of strokes per combustion cycle, operating a second cylinder group at a second number of strokes per combustion cycle, the second number of strokes per cycle being different than the first number of strokes per cycle.

### TECHNICAL FIELD

This disclosure pertains generally to exhaust-gas purification systems for engines, and more particularly, to selective catalytic reduction systems with on-board ammonia production.

### BACKGROUND

Selective catalytic reduction (SCR) provides a method for removing nitrogen oxides (NOx) emissions from fossil fuel powered systems for engines, factories, and power plants. During SCR, a catalyst facilitates a reaction between exhaust-gas ammonia and NOx to produce water and nitrogen gas, thereby removing NOx from the exhaust gas.

The ammonia that is used for the SCR system may be produced during the operation of the NOx-producing system or may be stored for injection when needed. Because of the high reactivity of ammonia, storage of ammonia can be hazardous. Further, on-board production of ammonia can be costly and may require specialized equipment.

### SUMMARY

In a first aspect there is disclosed a method of operating an engine system comprising operating a first cylinder group at a first number of strokes per combustion cycle, operating a second cylinder group at a second number of strokes per combustion cycle, the second number of strokes per cycle being different than the first number of strokes per cycle.

In a second aspect there is disclosed an engine comprising a first cylinder group configured to operate on a first type of combustion cycle, a second cylinder group configured to operate on a second type of combustion cycle, the first and second types of combustion cycles having different numbers of strokes.

In a third aspect there is disclosed an engine system comprising a first cylinder group configured to operate a first type of combustion cycle thereby creating NOx and a second cylinder group configured to operate a second type of combustion cycle thereby creating NOx, the second type of combustion cycle having a different number of strokes than the first type of combustion cycle. The engine system includes a first catalyst configured to receive NOx from the first cylinder group and to convert at least a portion of the NOx to NH3 the engine system further includes a second catalyst configured to receive NH3 from the first catalyst and NOx from the second cylinder group and further configured to promote a reaction between at least a portion of the NOx from the second cylinder group with at least a portion of the NH3 from the first catalyst.

### BRIEF DESCRIPTION OF THE DRAWINGS

FIG. 1 The accompanying drawings, which are incorporated in and constitute a part of this specification, illustrate exemplary embodiments of the disclosure and, together with the written description, serve to explain the principles of the disclosed system. In the drawings:

FIG. 1 provides a schematic diagram of a power source according to an exemplary disclosed embodiment.

FIG. 2 provides a diagrammatic representation of first and second cylinder groups according to an exemplary disclosed embodiment.

FIG. 3 provides a schematic diagram of first and second cylinder groups according to an exemplary disclosed embodiment.

FIG. 4 provides a schematic representation of a power source according to another exemplary disclosed embodiment.

FIG. 5A provides a schematic representation of an exhaust passage according to an exemplary disclosed embodiment

FIG. 5B provides a schematic representation of an exhaust passage according to another exemplary disclosed embodiment.

FIG. 5C provides a schematic representation of an exhaust passage according to another exemplary disclosed embodiment.

FIG. 6A provides a schematic representation of an exhaust system configuration according to an exemplary disclosed embodiment.

FIG. 6B provides a schematic representation of an exhaust system configuration according to another exemplary disclosed embodiment.

FIG. 7 provides a schematic representation of a power source according to another exemplary disclosed embodiment.

### DETAILED DESCRIPTION

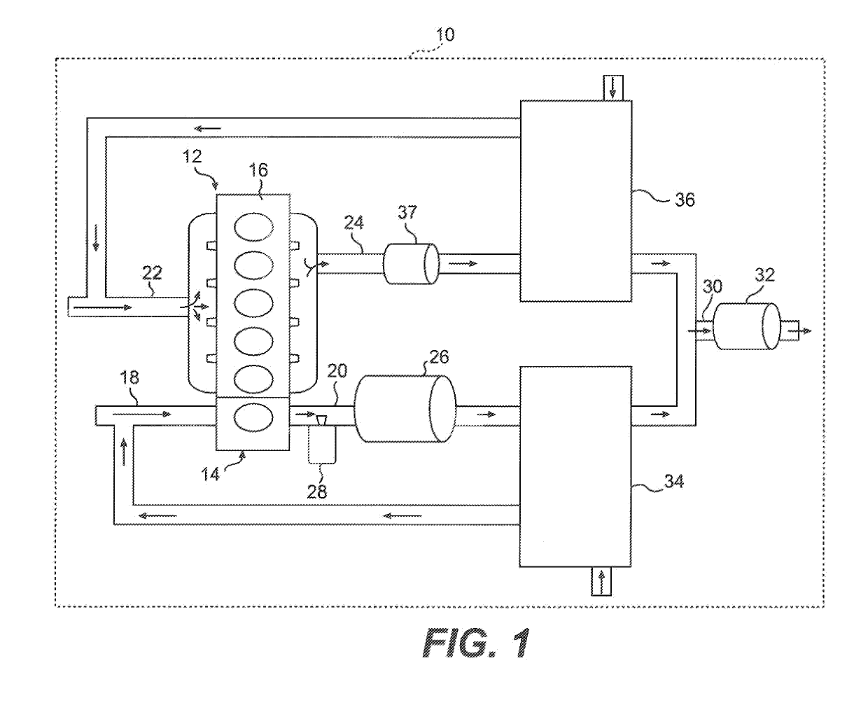

FIG. 1 provides a schematic representation of a machine 10 of the present disclosure including a power source 12. Power source 12 may include a first cylinder group 14 and a second cylinder group 16. First cylinder group 14 may be fluidly connected to a first air-intake passage 18 and a first exhaust passage 20. Second cylinder group 16 may be fluidly connected to a second air-intake passage 22 and a second exhaust passage 24. In one embodiment, first air-intake passage 18 is fluidly isolated from second air-intake passage 22.

In one embodiment, power source 12 of the present disclosure may include an ammonia-producing catalyst 26 that may be configured to convert at least a portion of the exhaust-gas stream from first cylinder group 14 into ammonia. This ammonia may be produced by a reaction between NOx and other substances in the exhaust-gas stream from first cylinder group 14. For example, NOx may react with a variety of other combustion byproducts to produce ammonia. These other combustion byproducts may include, for example, H₂ (hydrogen gas), C₃H₆ (propene), or CO (carbon monoxide).

Ammonia-producing catalyst 26 may be made from a variety of materials. In one embodiment, the ammonia producing catalyst 26 may include a perovskite like ABX3, where A and B are cations and X is an anion, e.g. CaTiO3. In one embodiment, ammonia-producing catalyst 26 may include at least one of platinum, palladium, rhodium, iridium, copper, chrome, vanadium, titanium, iron, or cesium. Combinations of these materials may be used, and the catalyst material may be chosen based on the type of fuel used, the air to fuel-vapor ratio desired, or for conformity with environmental standards.

First cylinder group 14 may include one or more cylinders, and second cylinder group 16 may include at least two cylinders. For example, first cylinder group 14 may include between one and ten cylinders, and second cylinder group 16 may include between two and twelve cylinders. In one embodiment, first cylinder group 14 may include only one cylinder, and second cylinder group 16 may include five cylinders. In another embodiment, first cylinder group 14 may include one cylinder, and second cylinder group 16 may include seven cylinders. In another embodiment, first cylinder group 14 may include one cylinder, and second cylinder group 16 may include eleven cylinders. The number of cylinders in first cylinder group 14 and the number of cylinders in second cylinder group 16 may be selected based on a desired power output to be produced by power source 12.

First cylinder group 14 may be provided with a first valve arrangement 60 (not shown) for controlling fluid flows in and out of any cylinders in the first cylinder group 14. The first valve arrangement 60 may be driven by a first actuation arrangement 64 (not shown). The actuation arrangement 64 may for example include a camshaft, solenoid, or fluid actuator. Second cylinder group 16 may be provided with a second valve arrangement 62 (not shown) for controlling fluid flows in and out of any cylinders in the second cylinder group 16. The second valve arrangement 62 may be driven by a first actuation arrangement 66 (not shown). The actuation arrangement 66 may for example include a camshaft, solenoid, or fluid actuator.

The first cylinder group 14 with its associated first valve arrangement 60 and first actuation arrangement 64 may be configured to operate at a first type of combustion cycle. The second cylinder group 16 with its associated second valve arrangement 62 and second actuation arrangement 62 may be configured to operate at a second type of combustion cycle. The first and second combustion cycles may have different number of strokes. In one embodiment the second cylinder group 16 may operate at a 4 stroke principle, i.e. operating sequences of intake, compression, power and exhaust strokes. The first cylinder group may operate at combustion cycles having a higher number of strokes per cycle. For example, the first cylinder group may operate at a 6, 8, 10 or 12 stroke cycle. A 6-stroke cycle may for example include a sequence of intake, first compression, first power, second compression, second power and exhaust strokes. A blowdown event may occur during or between the first power stroke and the second compression stroke to avoid undesirably high peak pressures in one or more cylinders. Additional fuel may be injected during the second compression and/or power stroke to aid the second power stroke.

Using different strokes per combustion cycles for the first and second cylinder groups 14,16 may enable the first cylinder group 14 to operate closer to stoichiometric combustion than the second cylinder group 16. Using different strokes per combustion cycles for the first and second cylinder groups 14,16 may enable the second cylinder group 16 to operate closer to lean combustion than the first cylinder group 14.

To enable the first and second cylinder groups 14,16 to operate at different combustion cycles, the first and second actuation arrangements 64, 66 may operate at different speeds. Where for example the first and second actuation arrangements 64, 66 are camshafts and the first and second cylinder groups 12, 14 operate at 6 and 4 stroke cycles respectively, the camshaft of the first actuation arrangement 64 may operate at ⅓ engine speed whereas the camshaft of the second actuation arrangement 66 may operate at ½ engine speed.

First exhaust passage 20 may fluidly communicate with second exhaust passage 24 at a point downstream of fuel-supply device 28 to form a merged exhaust passage 30. Merged exhaust passage 30 may contain a mixture of an exhaust-gas stream produced by second cylinder group 16 and an ammonia-containing, exhaust-gas stream produced by ammonia-producing catalyst 26 in first exhaust passage 20.

A NOx-reducing catalyst 32 may be disposed in merged exhaust passage 30. In one embodiment, NOx-reducing catalyst 32 may facilitate a reaction between ammonia and NOx to at least partially remove NOx from the exhaust-gas stream in merged exhaust passage 30. For example, NOx-reducing catalyst 32 may facilitate a reaction between ammonia and NOx to produce nitrogen gas and water, among other reaction products.

Power source 12 may include forced-induction systems to increase power output and/or control the air to fuel-vapor ratios within the cylinders of first cylinder group 14 or second cylinder group 16. Forced-induction systems may include, for example, turbochargers and/or superchargers. In one embodiment, a first forced-induction system 34 may be operably connected with first air-intake passage 18, and a second forced-induction system 36 may be operably connected with second air-intake passage 22.

In one embodiment, first forced-induction system 34 or second forced-induction system 36 may include a turbocharger. The turbocharger may utilize the exhaust gas in first exhaust passage 20 or second exhaust passage 24 to generate power for a compressor, and this compressor may provide additional air to first air-intake passage 18 or second air-intake passage 22. Therefore, if first forced-induction system 34 or second forced-induction system 36 includes a turbocharger, the turbocharger may be operably connected with both an exhaust passage 20, 24 and an air-intake passage 18, 22, as shown in FIG. 1.

In one embodiment, ammonia-producing catalyst 26 may be positioned downstream of first forced induction system 34. The exhaust stream in first exhaust passage 20 may be cooler downstream of first forced-induction system 34 than upstream of first forced-induction system 34. Ammonia-producing catalyst 26 may function more efficiently when exposed to a cooler exhaust-gas downstream of first forced-induction system 34.

In one embodiment, first forced-induction system 34 or second forced-induction system 36 may include a supercharger. A supercharger may derive its power from a belt that connects directly to an engine. Further, superchargers do not need to be connected with an exhaust stream. Therefore, if first forced-induction system 34 or second forced-induction system 36 includes a supercharger, the supercharger may be operably connected with first air-intake passage 18 or second air-intake passage 22, but the supercharger need not be operably connected with first exhaust passage 20 or second exhaust passage 24.

In an alternative embodiment, first air-intake passage 18 or second air-intake passage 22 may be naturally aspirated. A naturally aspirated air-intake passage may include no forced-induction system. Alternatively, an air-intake passage may include a forced-induction system, but the forced-induction system may be turned on and off based on demand. For example, when increased airflow is needed, first forced-induction system 34 or second forced-induction system 36 may be turned on to supply additional air to first air-intake passage 18 and/or second air-intake passage 22. When lower air-intake is needed, such as when little power is needed from power source 12, first air-intake passage 18 and/or second air intake passage 22 may be naturally aspirated. In one embodiment, second air-intake passage 22 may be operably connected with second forced-induction system 36, and first air-intake passage 18 may be naturally aspirated.

In one embodiment, second exhaust passage 24 may include an oxidation catalyst 37. NOx may include several oxides of nitrogen including nitric oxide (NO) and nitrogen dioxide (NO₂), and NOx-reducing catalyst 32 may function most effectively with a ratio of NO:NO₂ of about 1:1. Oxidation catalyst 37 may be configured to control a ratio of NO:NO₂ in second exhaust passage 24. Further, by controlling a ratio of NO:NO₂ in second exhaust passage 24, oxidation catalyst 37 may also control a ratio of NO:NO₂ in merged exhaust passage 30.

A variety of additional catalysts and/or filters may be included in first-exhaust passage 20 and/or second exhaust passage 24. These catalysts and filters may include particulate filters, NOx traps, and/or three-way catalysts. In one embodiment, first-exhaust passage 20 and/or second exhaust passage 24 may include, for example, one or more diesel particulate filters.

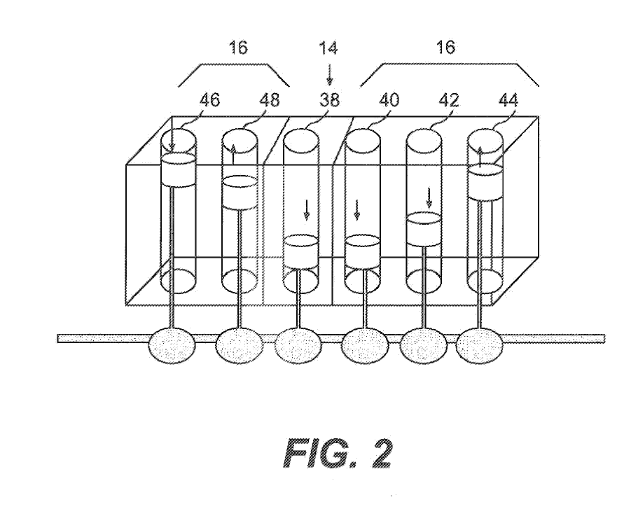

FIG. 2 provides a schematic diagram of power source 12 according to another exemplary disclosed embodiment. As described above, power source 12 may include first cylinder group 14 and second cylinder group 16, wherein first cylinder group 14 may be fluidly connected to first air-intake passage 18 and first exhaust passage 20, and second cylinder group 16 may be fluidly connected to second air-intake passage 22 and second exhaust passage 24.

In some embodiments, first air-intake passage 18 may be configured to provide air having a first set of characteristics to first cylinder group 14, and second-air intake passage 22 may be configured to provide air having a second set of characteristics to second cylinder group 16. Air-intake passages may be configured to modify one or more air properties, such as, for example, air pressure, flow rate or temperature. In particular, first air-intake passage 18 and second air-intake passage 22 may be configured such that air at the first set of characteristics may be different from air at the second set of characteristics, wherein the first and second set of characteristics may include one or more air properties. For example, first air-intake passage 18 may include a smaller cross-sectional area than second air-intake passage 22 to reduce the pressure of air supplied to first cylinder group 14. Supplying first cylinder group 14 and second cylinder group 16 with air at different properties may permit first cylinder group 14 and second cylinder group 16 to produce different emission levels while producing substantially similar power outputs from each cylinder.

In some embodiments, first air-intake passage 18 may be fluidly connected to second air-intake passage 22, wherein first air-intake passage 18 may include a valve 50. Valve 50 may include any device configured to modify one or more air properties. In particular, valve 50 may be configured to modify one or more air properties such that air downstream of valve 50 may have a first set of characteristics and air upstream of valve 50 may have a second set of characteristics. For example, valve 50 may be configured to reduce air pressure and/or flow rate downstream of valve 50. Valve 50 may be configured to reduce air pressure within first air-intake passage 18 relative to second air-intake passage 22 such that first cylinder group 14 may be supplied with air at a lower pressure than air supplied to second cylinder group 16.

Valve 50 may include a throttle, an inductive venturi aperture, or other similar device configured to modify an air property. In some embodiments, valve 50 may be configured to selectively modify an air property within first air-intake passage 18 during variable load operation of power source 12. For example, valve 50 may modify an air property based on an operational condition of power source 12, such as, engine speed or engine load. As engine speed increases valve 50 may increase the pressure difference between air in first air-intake passage 18 and second-air intake passage 22 by decreasing air flow rate through valve 50.

In some embodiments, first cylinder group 14 and second cylinder group 16 may operate with combustion reactions at different efficiencies. Supplying first cylinder group 14 and second cylinder group 16 with air at different properties may permit combustion reactions at different efficiencies within first cylinder group 14 and second cylinder group 16. Combustion reactions at different efficiencies may produce different combustion products and different levels of emissions from first cylinder group 14 and second cylinder group 16. For example, supplying first cylinder group 14 with air at a lower pressure than air supplied to second cylinder group 16 may permit first cylinder group 14 to produce increased levels of NOx relative to second cylinder group 16. Emission levels may also be affected by other operational parameters of power source 12, such as, for example, air to fuel-vapor ratio, valve timing, or fuel injection timing.

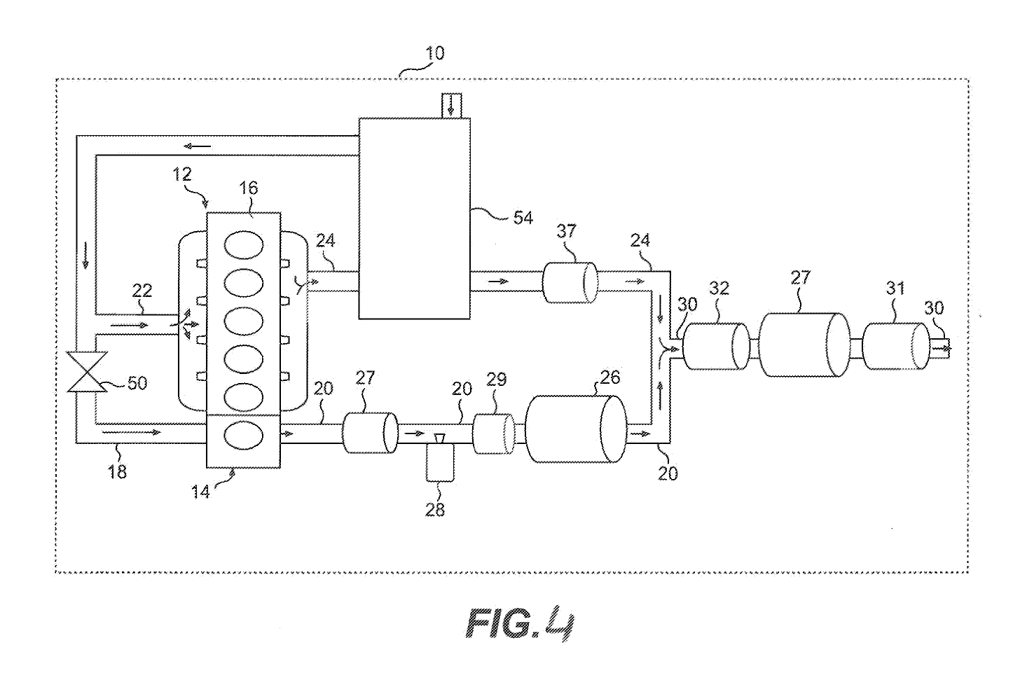

Power source 12 may include one or more forced-induction systems to increase power output, as previously described. As shown in FIG. 4, a forced-induction system 54 may be operably connected to second air intake passage 22 and first air-intake passage 18, wherein first air-intake passage 18 may include valve 50. Forced-induction system 54 may include a supercharger, operably connected to power source 12 via a belt and/or gear assembly. The supercharger may utilize a portion of the energy produced by power source 12 to compress air in first air-intake passage 18 and second air-intake passage 22, thereby increasing the power output of power source 12.

In some embodiments, forced-induction system 54 may include a turbocharger. As described above, the turbocharger may utilize the exhaust gas in second exhaust passage 24 and/or first exhaust passage 20 to generate power for a compressor. The compressor may further be configured to compress the air in first air-intake passage 18 and second air-intake passage 22.

Various catalysts and/or filters may be included in first-exhaust passage 20 and/or merged passage 30. Exemplary catalysts and filters may include particulate filters, NOx traps, and/or three-way catalysts. As described previously, first exhaust passage 20 may include fuel-supply device 28 and/or ammonia-producing catalyst 26 configured to facilitate ammonia production in first exhaust passage 20. First exhaust passage 20 may also include a diesel particulate filter 27, configured to collect solid and liquid particulate matter emissions. Diesel particulate filter 27 may also be disposed in merged exhaust passage 30. In addition, first exhaust passage 20 may also include a partial oxidation catalyst 29, configured to reduce emissions of gaseous hydrocarbons and liquid hydrocarbon particles.

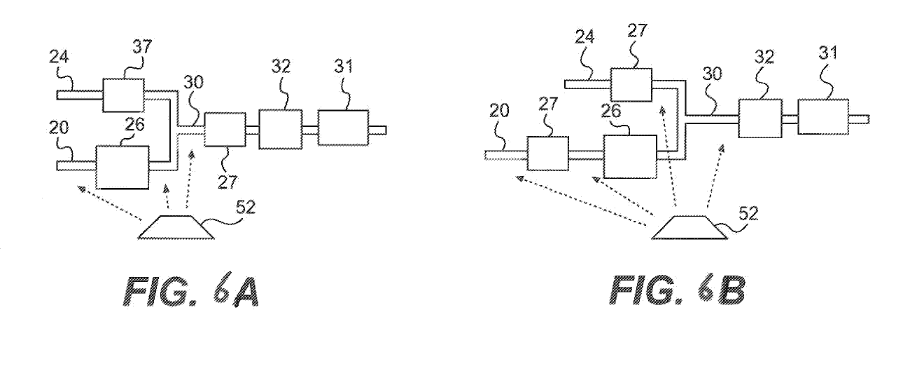

FIGS. 6A-6C provide schematic diagrams of first exhaust passage 20 according to several exemplary disclosed embodiments. As well as various catalysts and/or filters, first exhaust passage 20 may include a turbo-compound 52 configured to provide additional energy to machine 10. Turbo-compound 52 may be configured to convert energy in exhaust gases of power source 12 into rotational energy that may be added to power source 12.

As described above, exhaust gases in first exhaust passage 20 and/or second exhaust passage 24 may be used to drive a conventional turbocharger. Following passage through the conventional turbocharger, exhaust gases may then be directed into turbo-compound 52 to spin a turbine. The turbine may be configured to provide additional power to power source 12. For example, the revolutions of the turbine may be stepped down by mechanical gears and/or a hydraulic coupling to drive a shaft mechanically connected to power source 12.

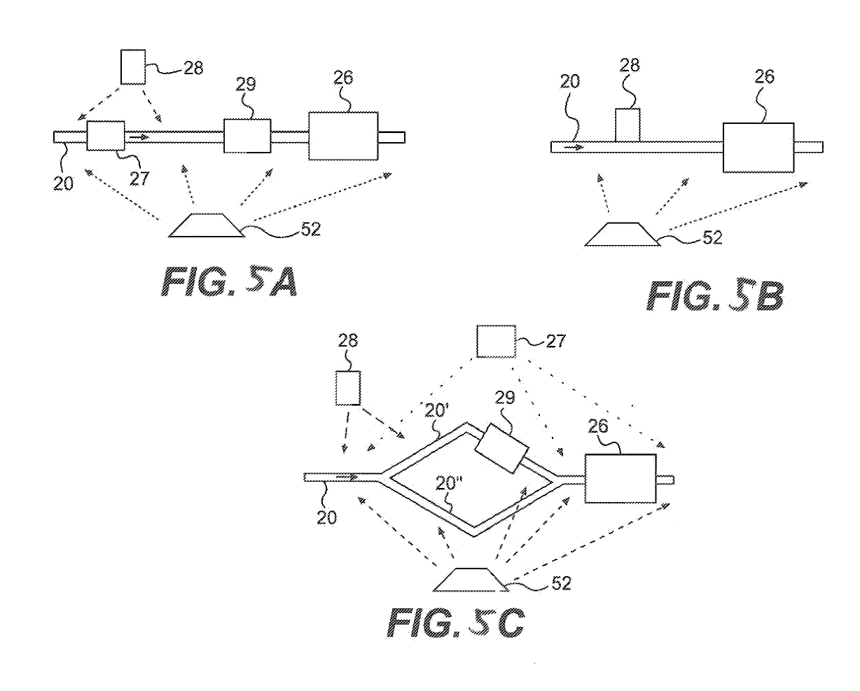

As shown in FIG. 5A, turbo-compound 52 may be placed at any position within first exhaust passage 20. Specifically, turbo-compound 52 may be located upstream or downstream of diesel particulate filter 27, partial oxidation catalyst 29 and/or ammonia-producing catalyst 26. Further, first exhaust passage 20 may or may not include fuel-supply device 28 upstream or downstream of diesel particulate filter 27.

In some embodiments, first exhaust passage 20 may include additional and/or fewer components. For example as shown in FIG. 5B, first exhaust passage 20 may include fuel-supply device 28 and ammonia-producing catalyst 26. First exhaust passage 20 may also include turbo-compound 52 located upstream or downstream of fuel-supply device 28 and ammonia-producing catalyst 26.

First exhaust passage 20 may include one or more branched configurations. As shown in FIG. 5C, first exhaust passage 20 may split into two sub-passages, a first exhaust sub-passage 20′ and a second exhaust sub-passage 20″. Each sub-passage may include at least one of the various catalysts, filters and/or turbo-compound 52. Specifically, first exhaust sub-passage 20′ may include fuel-supply device 28 and/or partial oxidation catalyst 29. First exhaust passage 20 may include diesel particulate filter 27 upstream or downstream of each sub-passage. It is also contemplated that turbo-compound 52 may be positioned anywhere within first exhaust passage 20, first exhaust sub-passage 20′, or second exhaust sub-passage 20″.

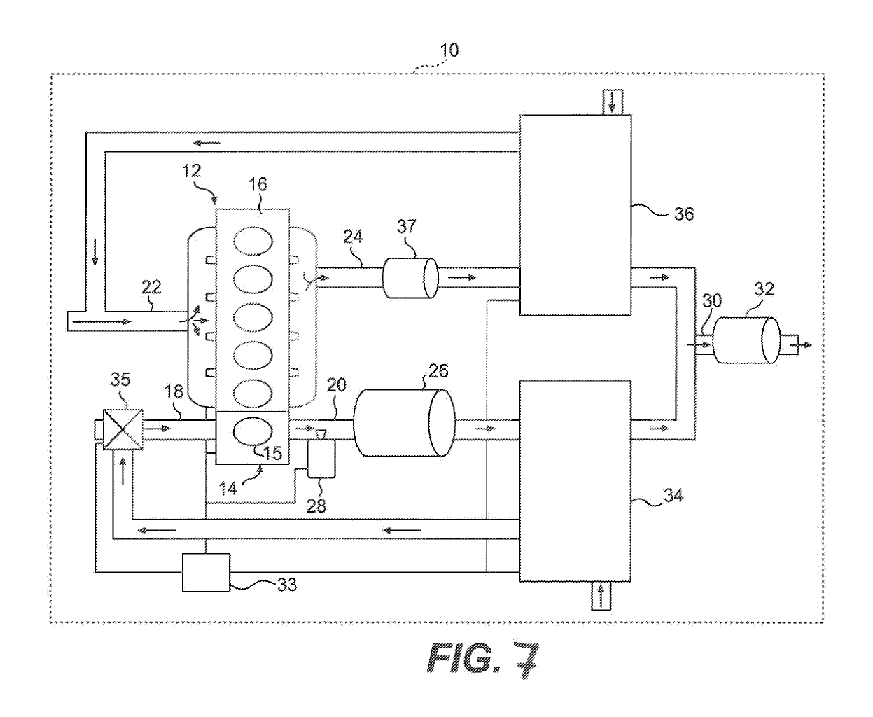

FIGS. 7A-7B provide schematic diagrams of one or more exhaust passages according to several exemplary disclosed embodiments. As discussed above, first-exhaust passage 20, second exhaust passage 24 and/or merged passage 30 may include various catalysts and/or filters. For example, merged passage 30 may include an ammonia-reducing catalyst 31 configured to remove ammonia from the exhaust gas to substantially prevent ammonia release to the atmosphere.

As shown in FIG. 6A, turbo-compound 52 may be placed at any suitable position within first exhaust passage 20 and/or merged passage 30. Specifically, turbo-compound 52 may be located upstream or downstream of ammonia-producing catalyst 26 in first exhaust passage 20. Turbo-compound 52 may also be located upstream of diesel particulate filter 27 in merged passage 30.

In some embodiments, first exhaust passage 20, second exhaust passage 24 and/or merged passage 30 may include additional and/or fewer components. For example as shown in FIG. 6B, first exhaust passage 20 may include diesel particulate filter 27 and ammonia-producing catalyst 26 and second exhaust passage 24 may include diesel particulate filter 27. Further, merged passage 30 may include NOx-reducing catalyst 32 and ammonia-reducing catalyst 31. Turbo-compound 52 may also be located upstream or downstream of diesel particulate filter 27 in first exhaust passage 20, upstream of NOx-reducing catalyst 32 in merged passage 30, or downstream of diesel particulate filter 27 in second exhaust passage 24.

FIG. 7 provides a schematic representation of a machine 10′, including a power source 12 according to another exemplary disclosed embodiment. This embodiment is similar to the embodiment of FIG. 1, wherein power source 12 may include a first cylinder group 14 and a second cylinder group 16. First cylinder group 14 may be fluidly connected to a first air-intake passage 18 and a first exhaust passage 20. Second cylinder group 16 may be fluidly connected to a second air-intake passage 22 and a second exhaust passage 24.

Machine 10′ further includes first and second forced-induction systems 34, 36 (e.g. turbochargers). First and second forced-induction systems 34, 36 may be configured to separately supply air to first air-intake passage 18 and second air-intake passage 22. In some embodiments, the separate forced-induction systems 34, 36 may allow rapid and accurate control of the power output within each of the cylinders of first cylinder group 14 and second cylinder group 16.

The power output of each of the cylinders of first cylinder group 14 and second cylinder group 16 may be controlled by a number of different factors, including, for example, air-to-fuel ratio, absolute amounts of air and fuel in the cylinders, and/or injection timing. In some embodiments, power source 12 may include an engine control unit 33, configured to control the power output of each of the cylinders of first cylinder group 14 and second cylinder group 16.

Control unit 33 may include a variety of suitable machine electronic control units. For example, control unit 33 may include one or more microprocessors, a memory unit, a data storage device, a communications hub, and/or other components known in the art. It is contemplated that control unit 33 may be integrated within a general control system capable of controlling various functions of power source 12 and/or other components of machine 10. Further, control unit may determine various machine operational parameters and deliver output signals to effect desired operation by power source 12 or any other exhaust system or machine components.

In some embodiments, control unit 33 may control the amount and timing of air and/or fuel supplied to the cylinders of power source 12. For example, control unit 33 may control the operation of turbochargers 34, 36 to control cylinder air-fuel ratios. In addition, first and or second intake passage 18, 22 may further include suitable valves 35 or other systems for controlling the supply of air through from turbochargers 34, 36 or an intake manifold.

In addition, control unit 33 may control the amount and timing of fuel supplied to cylinders of power source 12. For example, first and second cylinder groups 14, 16 may include fuel supply systems, such as fuel injectors 15, 17. Control unit 33 may be configured to control fuel injection to control the power output and emissions from each cylinder of first and second cylinder groups 14, 16.

In some embodiments, control unit 33 may be configured to produce a substantially equal power output from each of the cylinders of first and second cylinder groups 14, 16 to control power source vibration. Further, while producing substantially equal power outputs from each cylinder, control unit may effect production of different exhaust gas compositions. For example, as noted previously, it may be desirable to produce a higher amount of NOx in first cylinder group 14, thereby allowing NOx to be converted to ammonia at a downstream ammonia-producing catalyst 26.

### INDUSTRIAL APPLICABILITY

The present disclosure provides an exhaust-gas purification system including a power source with on-board ammonia production. This purification system may be useful in all engine types that produce NOx emissions.

The operation of engine cylinders may be dependant on the ratio of air to fuel-vapor that is injected into the cylinders during operation. The air to fuel-vapor ratio is often expressed as a lambda value, which is derived from the stoichiometric air to fuel-vapor ratio. The stoichiometric air to fuel-vapor ratio is the chemically correct ratio for combustion to take place. A stoichiometric air to fuel-vapor ratio may be considered to be equivalent to a lambda value of 1.0.

Engine cylinders may operate at non-stoichiometric air to fuel-vapor ratios. An engine cylinder with a lower air to fuel-vapor ratio has a lambda less than 1.0 and is said to be rich. An engine cylinder with a higher air to fuel-vapor ratio has a lambda greater than 1.0 and is said to be lean.

Lambda may affect cylinder NOx emissions and fuel efficiency. A lean-operating cylinder may have improved fuel efficiency compared to a cylinder operating under stoichiometric or rich conditions. However, lean operation may increase NOx production or may make elimination of NOx in the exhaust gas difficult as residual oxygen in the exhaust stream may negatively affect NOx to NH3 conversion.

The cylinders of first cylinder group 14 and/or second cylinder group 16 may include a variety of suitable engine cylinder types. For example, suitable engine types may include diesel engine cylinders, natural gas cylinders, or gasoline cylinders. The specific cylinder type may be selected based on the specific application, desired power output, available fuel infrastructure, and/or any other suitable factor. For example, natural gas engines may be selected for some engine types, such as generator sets. Diesel engines may be selected for on-highway trucks. However, as the available fuel infrastructure, fuel costs, and emission standards change, different engine types may be selected for any application.

SCR systems provide a method for decreasing exhaust-gas NOx emissions through the use of ammonia. In an exemplary embodiment of the present disclosure, engine NOx generated by a first type of combustion cycle in first cylinder group 14 may be converted into ammonia. This ammonia may be used with an SCR system to remove NOx produced as a byproduct of fuel combustion in power source 12.

Stoichiometric operation of first cylinder group 14 may allow better controlled NOx production as compared to lean or rich operation of first cylinder group 14. Further, the efficiency of conversion of NOx to ammonia by ammonia-producing catalyst 26 may be improved under rich conditions. Therefore, fuel may be supplied to this NOx-containing exhaust gas to produce a rich, NOx-containing exhaust gas that can be used to produce ammonia by ammonia-producing catalyst 26.

In one embodiment the first cylinder group 14 may operate at a first number of strokes per combustion cycle and the second cylinder group 16 may operate a second number of strokes per combustion cycle whereby the second number of strokes per cycle is different than said first number of strokes per cycle. In one embodiment the second cylinder group 16 may be operating at a 4-stroke cycle whilst the first cylinder group 14 may operate at a cycle containing more than 4 strokes such as for example a 6, 8, 10, or 12 stroke cycle. In one embodiment the number of strokes per cycle for the first cylinder group 14 may be changed whilst the power source 12 is running. For example, the first cylinder group 14 may operate at a 6 stroke cycle for a period of time and may operate at a different number of strokes per cycle for another period of time. The periods of time may for example be dependent on load, speed, desired emission characteristics, and/or desired fuel consumption. In one embodiment the first cylinder group 14 may specifically operate at a 6-stroke cycle and the second cylinder group 16 may operate at a 4-stroke cycle.

In embodiments wherein the first cylinder group 14 runs at a cycle having a greater number of strokes than cycle of the second cylinder group 16, the first cylinder group 14 may be operating closer to stoichiometric than the second cylinder group 16. In addition or as an alternative, in embodiments wherein the first cylinder group 14 runs at a cycle having a greater number of strokes than cycle of the second cylinder group 16, the second cylinder group 16 may be operating leaner, i.e. on a leaner air-to fuel ratio, than the first cylinder group. In one embodiment wherein the first cylinder group 14 runs at a cycle having a greater number of strokes than cycle of the second cylinder group 16, the first cylinder group 14 may be operating substantially stoichiometric and the second cylinder group may be operating substantially lean.

In one embodiment, first cylinder group 14 may operate with a stoichiometric air-to-fuel ratio within the one or more cylinders of first cylinder group 14. The one or more cylinders of first cylinder group 14, operating with a stoichiometric air to fuel-vapor ratio, may produce a stoichiometric exhaust-gas stream that contains NOx. The stoichiometric, NOx-containing exhaust-gas stream may flow into first exhaust passage 20, which may be fluidly connected with the one or more cylinders of first cylinder group 14.

In order to produce the rich conditions that favor conversion of NOx to ammonia, a fuel-supply device 28 may be configured to supply fuel into first exhaust passage 20. In one embodiment, a stoichiometric, NOx-containing exhaust-gas stream may be delivered to first exhaust passage 20, and fuel-supply device 28 may be configured to supply fuel into first exhaust passage 20, thereby making the exhaust-gas stream rich. In one embodiment, the exhaust-gas stream in first exhaust passage 20 may be stoichiometric upstream of fuel-supply device 28 and rich downstream of fuel-supply device 28.

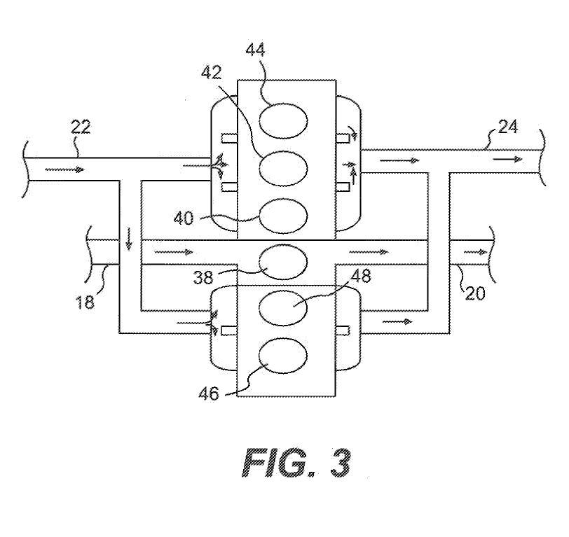

FIG. 3 illustrates the fluid communications of air-intake passages and exhaust passages with the cylinders of FIG. 2. In this embodiment, first air-intake passage 18 and first exhaust passage 20 may fluidly communicate with single cylinder 38 of first cylinder group 14. Further, second air-intake passage 22 may fluidly communicate with cylinder 40 of second cylinder group 16, as well as all the other cylinders 42, 44, 46, 48 of second cylinder group 16, and second air-intake passage 22 may be fluidly isolated from first air-intake passage 18. In addition, second exhaust passage 24 may fluidly communicate with cylinder 40 of second cylinder group 16, as well as all the other cylinders 42, 44, 46, 48 of second cylinder group 16.

Controlling the power outputs of each of the cylinders of power source 12 may affect ammonia production, NOx emissions, maximum power output, and/or fuel efficiency. For example, when increased power output is needed, all cylinders of power source 12 may operate at maximum power. In another embodiment, the power output of any one of the one or more cylinders of first cylinder group 14 may be less than the power output of each of the cylinders of second cylinder group 16. In such an embodiment, first cylinder group 14 may produce less power, but the operation of first cylinder group 14 may be controlled to match ammonia production with NOx production from second cylinder group 16.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the embodiments disclosed herein. It is intended that the specification and examples be considered as exemplary only, with a true scope of the disclosure being indicated by the following claims and their equivalents.

What is claimed is:

1. A method of operating an engine system comprising:
operating a first cylinder group at a first number of strokes per combustion cycle;
operating a second cylinder group at a second number of strokes per combustion cycle, said second number of strokes per cycle being different than said first number of strokes per cycle.

2. A method according to claim 1, further including operating said first cylinder group closer to stoichiometric than said second cylinder group.

3. A method according to claim 1, further including operating said second cylinder group leaner than said first cylinder group.

4. A method according to claim 1, further including operating said first cylinder group substantially stoichiometric and operating said second cylinder group substantially lean.

5. A method according to claim 1, further including converting at least a portion of NOx generated during a combustion cycle in said first cylinder to NH3.

6. A method according to claim 5, further including treating at least a portion of NOx generated during a combustion cycle in said second cylinder with said NH3.

7. A method according to claim 1, further including changing the number of strokes of at least one of said first and second cylinder groups during operation of the engine.

8. An engine comprising:
a first cylinder group configured to operate on a first type of combustion cycle;
a second cylinder group configured to operate on a second type of combustion cycle, the first and second types of combustion cycles having different numbers of strokes.

9. An engine according to claim 8, wherein said second type of combustion cycle has less strokes than said first type of combustion cycle.

10. An engine according to claim 8, wherein said first type of combustion cycle is a 6-stroke cycle and said second type of combustion cycle is a 4-stroke cycle.

11. An engine according to claim 8, wherein said first type of combustion cycle is closer to stoichiometric combustion than said second type of combustion cycle.

12. An engine according to claim 8, wherein said second type of combustion cycle is closer to lean-burn combustion than said first type of combustion cycle.

13. An engine according to claim 8 wherein said engine is an in-line engine and said first cylinder group is provided with a first set of valves actuated by a first camshaft and said second cylinder group is provided with a second set of valves actuated by a second camshaft.

14. An engine according to claim 13 wherein said first and second camshafts operate at ⅓ A and ½ A engine speed respectively.

15. An engine according to claim 8, wherein the number of strokes in at least one of said first and second combustion cycles can be changed whilst the engine is operating.

16. An engine system comprising:
a first cylinder group configured to operate a first type of combustion cycle thereby creating NOx;
a second cylinder group configured to operate a second type of combustion cycle thereby creating NOx, said second type of combustion cycle having a different number of strokes than said first type of combustion cycle;
a first catalyst configured to receive NOx from said first cylinder group and to convert at least a portion of said NOx to NH3;
a second catalyst configured to receive NH3 from said first catalyst and NOx from said second cylinder group and further configured to promote a reaction between at least a portion of the NOx from said second cylinder group with at least a portion of the NH3 from said first catalyst.

17. An engine system according to claim 16, wherein said first type of combustion cycle includes the following strokes:
a first compression stroke;
a first power stroke;
a second compression stroke;
a second power stroke;
an exhaust stroke
an intake stroke.

18. An engine system according to claim 17, wherein a blowdown event occurs during at least one of the first power stroke and the second compression stroke.

19. An engine system according to claim 17, wherein a quantity of fuel is injected towards the end of the second compression stroke or near the beginning of the second power stroke.

20. An engine system according to claim 16, further comprising a controllable by-pass configured to provide a controllable first catalyst by-pass for the NOx from said first cylinder group.
